(19) United States
(12) Patent Application Publication
(10) Pub. No.: US 2013/0220958 A1
(43) Pub. Date: Aug. 29, 2013

(54) CUBE CONNECTION

(71) Applicant: Peter A. Mueller, Gattikon (CH)

(72) Inventor: Peter A. Mueller, Gattikon (CH)

(21) Appl. No.: 13/882,301

(22) PCT Filed: Oct. 27, 2011
(86) PCT No.: PCT/CH2011/000264

§ 371 Date: Apr. 29, 2013

(30) Foreign Application Priority Data
Oct. 27, 2010 (CH) 1788/10

(51) Int. Cl. A47F 5/01; F16B 7/00

(52) U.S. Cl. CPC A47F 5/01; F16B 7/00
USPC 211/182

(57) ABSTRACT

The invention relates to a cube (4) that connects straight pipes (2) or bent pipes (2a) with a minimum number of threaded holes (5) to a node (3) by means of connecting means (1) and/or a joint (1a), and the bent pipes (2a) are connected to the corresponding nodes (3) by means of threaded holes (5) that are bored at an angle and a flexible bend-clamping device (10) or bend-expanding means (14) or a joint (1a).

### TECHNICAL FIELD

The invention relates to a connection between a pipe and a distributor node, particularly for furniture elements, according to the preamble of the first claim.

### PRIOR ART

Connecting means for cube-type pieces of furniture are known in the art and allow for a variety of combinations of such cuboids by placing them upright or lying them flat, and they are easily combined with diverse intermediate elements. A wide spectrum of furniture ranging from wardrobes to tables, open or closed, for private living or office spaces, etc. can be produced in this manner.

Known in the art is the company USM, which connects a correspondingly length-adjusted pipe with a sphere using a clamping-type connecting means. Said sphere is able to accommodate further pipes such that a cube is created in the end that can be designed as open or with side panels, and which is able to accommodate doors that are mounted thereto.

On the one hand, modular systems of this kind are supposed to have a pleasing appearance while providing, on the other hand, stability and allowing for quick assembly and/or disassembly at a later time, if necessary. Most of these systems are rectangular in terms of structure, as described in patent specifications DE 2644370, EP 1116457, EP 1030066 or EP 628736; angular forms are unusual but known as well, for example as described in specification EP 686363.

### DESCRIPTION OF THE INVENTION

The underlying object of the invention is to create a modular piece of furniture having a minimum number of threaded holes and offering the possibility of also having the option of implementing a modular system of this kind with curved pipes as well.

The concept of having modular elements is interesting because, in the past, it has helped save production and warehousing costs, as well as operating expenditures in production, even assembly. In particular, straight connecting pipes are easy and cheap to produce and handle and therefore useful to have available.

Today, when it is possible to generate even complex geometries with extreme efficiency on modern CNC machines, using modern computers and minimal programming complexities, even a large number of diverse connecting elements, node elements and pipe lengths—stored previously in a library—can be electronically and directly handed off to the CNC machine. This way, parts can be produced just in time and stored fully automatically for assembly (pick and place); moreover, it is possible for an object to be produced according to customer wishes, simultaneously generating an optimally suited construction plan including correct instrumentation and assembly sequence such that, based on an intelligent structure, a modular piece of furniture can still be seen as characterized by the modularity thereof. Cost-efficient production, meaning the software-based creation of diverse components, calls for a higher initial work complexity, which must be completed only once, however, and after which time the system produces optimal node elements—variable number of threaded holes and connecting modes—and pipes automatically, such that a homogenous modular piece of furniture is built for the observer.

A central aspect of the invention addresses the fact that until now, based on a single or in part a single alternate node, innumerable threaded holes were provided and available for use, a great number of which, however, would in fact never be used. Advertisers suggest that said threaded holes could be needed at a later time for adding an additional piece of furniture and that, should this case indeed arise, the threaded assembly hole would already be available, thus allowing for the assembly of an additional component involving a minimum of complexity and effort. Calculations have shown that exchanging an end node with an expandable node is by far cheaper that stubbornly providing all nodes with threaded holes just in case that a rare retrofitting measure were to become necessary. In addition, another object of the invention seeks to implement an object with minimal expenditure of energy, while improving the esthetic effect even further. An example is a modular object that is combined into one body using four modules. Today, 108 threaded holes are needed for such a body, meaning a hole is drilled first and the corresponding thread is added in a further operating step. By optimizing the system, only 36 threaded holes are now needed, meaning two thirds fewer threaded holes, in addition, 36 holes for preparing the modules as a mounting frame. This way, it is possible to save 50% energy in the production of the parts.

Nodes of this kind that accommodate innumerable open and unused threaded holes are, on the one hand, no longer esthetically pleasing while, on the other hand, open holes can become dusts traps and become a home for other unwelcome items and creatures. Threaded holes that are needed for a lateral expansion of a piece of furniture must be elegantly covered up in the interim by a protective cover, possibly displaying a logo to increase product recognition.

Owing to the use of modern CNC machines and smart software, it is no longer cost-prohibitive to implement threads of another than a rectangular design, thereby providing the customer with added value in that pipes are no longer just straight or continued in an angular fashion at each node; instead, it is now possible to introduce, together with novel connecting means, a soft wavy form into the modular furniture world.

A new connecting means was developed for this purpose that is able to create frictional as well as positive connections and/or joints for curved pipes. in places where a detachable connection is provided, a flexible clamping device clamps the curved pipe to the node; and where a detachable connection is not obligatory, the same is achieved by providing a joint. Furthermore, assembly of this type points the way to a new direction in preassembly, thereby also helping to reduce production complexity and costs.

The invention seeks to provide a cost-effective solution for providing modular systems in the furniture arena in that, by the targeted use of software and intelligent machine control systems, node points are not produced stereotypically, run-of-the-mill with a maximum number of possible threaded holes but that, to the contrary, when not necessarily required, no threaded holes are provided, thereby incurring lower production costs and better optical appearance. The possible variety of angular positions of the threaded holes allows, without incurring additional costs therein, for the use of curved pipes as well as, owing to a smart connection of the pipes, ultimately setting new accents in the optical appearance of office and living spaces.

According to the invention, this object is achieved by the characteristics of the first claim.

The core of the invention provides that by means of the connecting means, which can provide frictional as well as positive connections, and a software for the production of a minimum number of threaded holes it is possible to drastically lower the energy expenditure in the production of the parts, while simultaneously increasing the variability of the modules ranging to curved pipe connections that can be detached or, if necessary, expanded at any time in the way of a furniture module.

Further advantageous embodiments of the invention can be derived from the dependent claims.

### BRIEF DESCRIPTION OF THE DRAWINGS

Below, embodiments of the invention are described in further detail using the drawings. Same elements in different figures are identified by same reference signs.

Shown are as follows:

FIG. 1 shows a schematic top view of elements for the rational manufacture and assembly into furniture-type cubes made of pipes and nodes that are connected to each other by certain means, as well as a three-dimensional view of such pieces of furniture.

FIG. 2 shows a schematic side view of a node having three flanged sockets, wherein one of the pipes is disposed at an angle that is not a right angle relative to the two other pipes and configured as curved having a flexible clamping device that is accessible from the side of the node.

FIG. 3 shows a schematic side view of a node having three pipe sockets, wherein one of the pipes is disposed at an angle that is not a right angle relative to the two other pipes and configured as having a curved, expandable clamping device with access from the side of the curved pipe.

FIG. 4 shows a schematic side view of a node having three pipe sockets, wherein one of the pipes is disposed at an angle that is not a right angle relative to the two other pipes and not directed to the center point of the node, and the pipe is configured as curved having a flexible clamping device with access from the side of the curved pipe.

FIG. 5 shows a schematic side view of a node having three pipe sockets, wherein one of the pipes is disposed at an angle that is not a right angle relative to the two other pipes and mounted to which is a rigid guide part with a positioning element, and the pipe is mounted to the guide part by means of a joint.

FIG. 6 shows a schematic side view of a straight pipe socket with a screw inserted therein that is screwed in at the location of a node, and located there-between are cut-open expanding elements with tapered intermediate elements, as well as a threaded hole with a protective cover.

For an immediate understanding of the invention, essential elements are only shown schematically.

### PATHS TO EMBODYING THE INVENTION

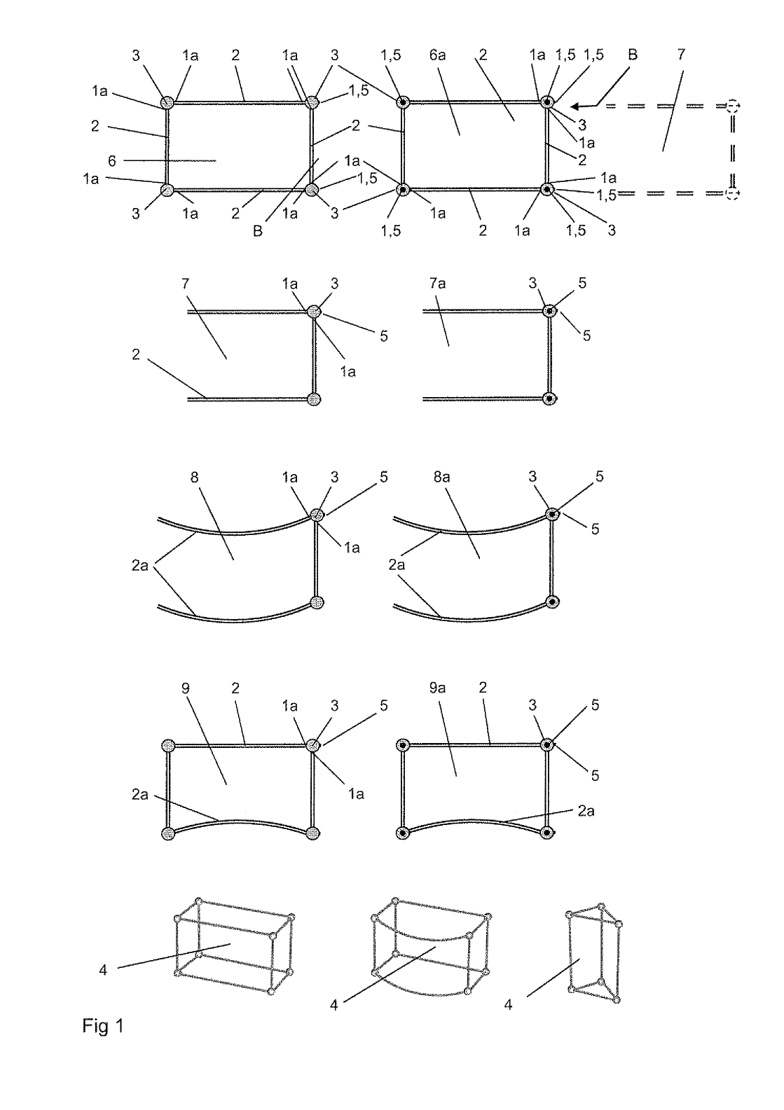

FIG. 1 shows a schematic top view of elements for the rational production and assembly of a connecting means 1 between pipe 2 and node 3 on a part of a cube 4 for furniture and the threaded holes 5, wherein the elements can be present as closed or open, rectangular or curved or partially curved frames 6, 7, 8, 9.

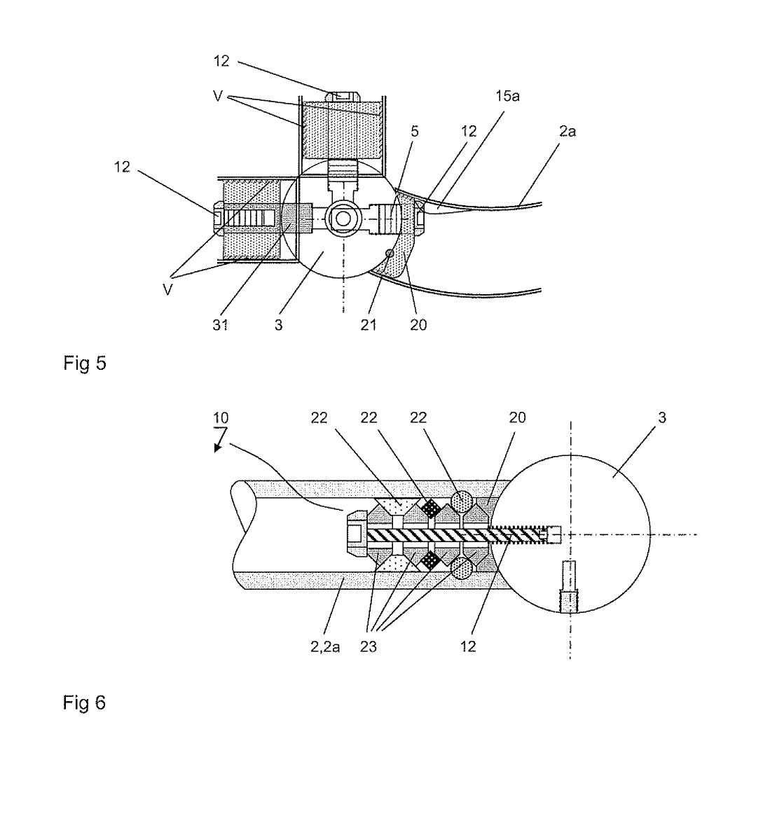

The cube 4 is not considered a cube in the strict sense of mathematic cuboid geometry; instead the term designates the presence of 8 corner points of a cuboid, or the 6 corners of a triangular body and stands, therefore, synonymous for a three-dimensional body. Modular furniture is characterized by the fact that a connecting means 1 is screwed to a node 3, and the pipe 2 is pushed over the same and connected to the connecting means 1 by a frictional or positive connection by means of a clamping screw. This is how pipes 2 with nodes 3 provided on each side thereof, and inside which there is located the connecting means 1, are screwed together. It is standard for nodes to have six threaded holes 5 to allow for the installation of further pipes 2 that are disposed at an angle of 90°, respectively. The inventive step is based on a completely different principle, namely that at locations where repeatedly recurring connection functions are created, a basic frame is produced, respectively, constituting a fixedly connected unit. This frame 6 also serves as an element for the lateral d expansion, which is ensured by other elements, for example u-shaped elements. The frame 6 is a single-part element, meaning the node 3 is connected to the pipe 2 by means of a joint 1a. Joint 1 a can be advantageously created by means of welding, soldering, gluing or shrinking. To this end, the node 3 advantageously includes a guide stump 20, as described in FIGS. 4 and 5 by which the joint can be optimally utilized.

The great majority of modules are never used as corner means to continue a row of modules at a right angle; nevertheless, most nodes 3 that are on the market feature the corresponding threaded holes 5 in the front sides thereof, which are therefore completely unnecessary. Similarly, it is unlikely that the customer would want to add vertically in both directions to his piece of furniture, meaning that the nodes 3 visible on top do not have to include unnecessary threaded holes 5, and unnecessary threaded holes 5 do not have to be provided at least on one side of such a cube 4. The rear of such a cube 4 corresponds to the front, and all unnecessary threaded holes 5 can be omitted there as well. This way, it is possible to assemble a very simple, efficient modular furniture cube 4; namely, by starting with a frame 6 that is without threaded holes 5 on the top side and that has on the one side thereof, as indicated by arrow B, nodes 3 with one threaded hole 5, respectively, offering options for expansion. The frame 6a disposed there-beneath includes threaded holes 5 on side B as well, and in the vertical line, one threaded hole 5 per node 3, respectively. This is how a modular tower can be assembled, such as a wardrobe or container or side/end table or something similar. If the customer wishes an expansion to the side, all that is required is a u-shaped half-frame 7 that has the same construction with regard to the nodes 3 as the frame 6, except that the two longitudinally disposed pipes 2 do not include their own nodes 3, but that they are connected to the nodes 3 of frame 6. The half-frames 7a disposed there-beneath are treated in the same manner as frame 6a.

Using this assembly technique and the connecting means 1 as well as the joint 1a, as described below, the use of curved pipes 2a is possible as curved frame 9 or curved half-frame 8; they can have a concave or convex shape and offer further options promising cost-effectiveness and optimum quality, when being mounted to the curved frame 9a or half-curved frame 8a there-beneath and then mounted in the same way as the frames 6, 6a, 7, 7a to constitute cube 4.

Particularly the curves frames 9 and curved half-frames 8 result in a completely new appearance of modular furniture in private living and business spaces; they can be combined such that, viewed from the top and transversely from the side, they represent a wave, or they can also be assembled into a circular shape.

It is also conceivable to fixedly connect not only the horizontal pipes 2 but also the vertical pipes 2 with the nodes 3; specifically, in places with major recurring volumes, for example book shelves and the like, it is possible to fixedly connect vertical pipes 2 to the node 3, and prefabricate these frames as complete cubic elements that only require being screwed together using connecting means 1.

Therefore, using a software product, not only is it possible to calculate the correct number of pipes (2, 2a) or number of nodes (3) but to select at the same time those nodes (3) with the lowest possible number of visible threaded holes 5; subsequently, the customer can decide if such a piece of furniture should be expandable or not, which in turn has an influence on the number of threaded holes based upon which the software calculates the optimal construction plan, such as, for example, as to whether work on the center curved part is to start immediately or at a later time, and which parts have a detachable connection 1 or a quick, therefore rigid, joint la, wherein production and warehousing tasks can be controlled as well.

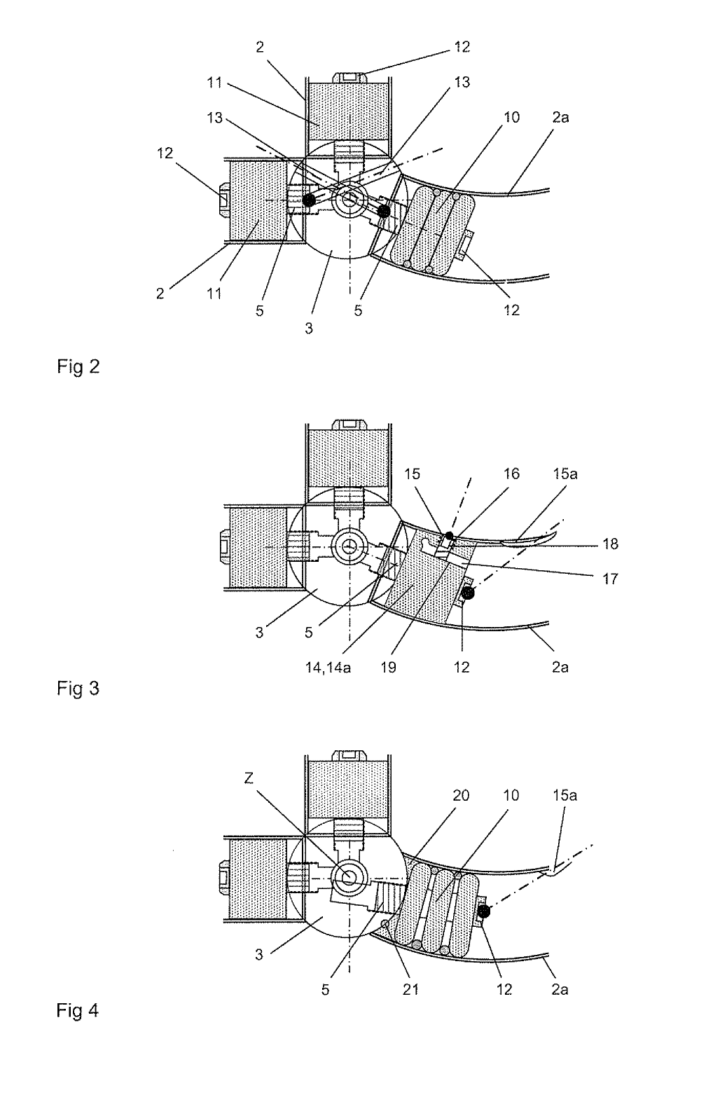

FIG. 2 shows a schematic side view of a node 3 with three pipes 2, 2a, wherein one of the pipes is not disposed at a right angle relative to the two straight pipes; this pipe 2a is curved and configured with a flexible bend-clamping device 10, as described in FIG. 6, that is accessible from node 3, and the two other pipes 2 include a straight clamping device 11. The construct of the two pipes 2 that are arranged at a right angle relative to each other and connected to node 3 by means of the clamping device 11 corresponds to the prior art using a screw 12 that engages in the threaded hole 5 in the node 3 in order to spread the clamping device 11, thereby creating a frictional connection. Also existing are clamping devices that engage laterally, by means of a screw 12, in a pin that is mounted on the node 3, and a thread is incorporated in pipe 2 thereby creating a frictional or also positive connection between pipe 2 and node 3.

This is different with regard to a curved pipe 2a, which can have different radii depending on the length of the pipe and which, nevertheless, must be safely clamped to the respective node 3 just as quickly. The curved pipe 2a originates at node 3 with a freely selectable angle other than the standard 90° angle by means of the threaded hole 5, such that a solid, stable radius of a curved pipe 2a is created from one node 3 to the next. Specification EP 686363 assumes the presence of a separate angular threaded hole 5 from the existing six threaded holes 5, while, presently, the production type is certainly not assumed to be the six-fold number of threaded holes 5, because a module abeam of the curved module is not provided; instead, corresponding maintenance holes 13 are available such that the screws 12 can be fastened and loosened along a short path to thus activate and/or deactivate the clamping action. To clamp the curved pipe 2a on the node 3, a flexible bend-clamping device 10, which is described in detail in FIG. 6, is incorporated allowing access to the screw 12 in different ways. In this instance, maintenance holes 13 are provided that are arranged such at an angle that, on the one hand, using a hex head screw driver with ball end allowing for standard screw fastening action up to an angular offset to 30°, presently shown as a perforated line, adjustments can be made and, on the other hand, that the maintenance hole 13 is covered up by pipes 2 or never covered up. This allows for a short access path to the screw 12 of the clamping device 11 and the bend-clamping device 10. The horizontal alignment of the curved pipe 2a is described in FIGS. 4, 5; a separate template ensures alignment otherwise.

FIG. 3 shows a schematic side view of a node 3 with three pipes 2, 2a, wherein a curved pipe 2a is not disposed at a right angle relative to the other two straight pipes 2 and provided with a bend-expanding means 14 that includes a maintenance opening 15 on the side of the curved pipe 2a offering easy access by means of a screw driver, presently shown as a perforated line, or by providing that the bend-expanding means 14 is placed in the curved pipe 2a in advance and fastened therein, and whereby afterwards it is possible to reach the screw 12 through the maintenance opening 15a transversely using a hex head screw driver, presently shown as a perforated line, in order to thus reach the screw 12 and connect the curved pipe 2a to the node 3.

To protect the curved pipe 2a against localized pressures and preserve pipe 2a as being thin-walled, the bend-expanding means 14 is, on the one hand, dimensioned large enough that the expansion stress per mm² is tolerable at any time, and that the expanding body 14a as well as the interior of the curved pipe 2a are advantageously worked using a granularity-type means, for example by means of sand blasting, such that upon expanding, a micro-positive connection is created and thus requiring a lower expansion force than for a frictional connection with identical tensile load requirements; plus, the thread 16 for expanding the bend-expanding means 14, which is located in a part of the expanding body 14a that is executed with a slot 17 and that, by inserting the setscrew 18, which is positioned quasi at a right angle relative to the bend-expanding means 14, the same presses bend-expanding means 14 against the interior wall 19 such that an expansion action of the expanding body 14a is generated, whereby the bend-expanding means 14 completely fulfills the intended function thereof.

It is not absolutely required that the bend-expanding means 14 must be fastened to the node 3 by means of screw 12; it is also conceivable to pre-install the bend-expanding means 14 by means of screw 12 or by rivet means or a joint 1a, the bent pipe 2a is pushed over the bend-expanding means 14 and clamped by means of the setscrew 18. The horizontal alignment of the curved pipe 2a is described in FIGS. 4, 5. The bend-expanding means 14 is also expedient for use together with straight pipes 2; for this purpose, the part is executed as cylindrical. If the setscrew 18 protrudes from pipe 2, 2a, a separate positive connection is ensured as well.

FIG. 4 shows a schematic side view of a node 3 with three pipes 2, 2a, wherein a curved pipe 2a is not disposed at a right angle relative to the other two pipes 2 and is provided with a curved clamping device 10 that is accessible through the maintenance opening 15, shown as a perforated line, wherein the turning of the screw 12, which is located inside the threaded hole 5 and disposed off center, is thereby simplified, meaning the threaded hole 5 is not directed to the center Z of the node 3. A curved guide stump 20, similar to a horn, ensures that the curved pipe 2a is automatically placed at the correct angle relative to the node 3; and, by means of the positioning pin 21, it is ensured that the curved pipe 2a is positioned horizontally as a curved frame 9 or curved half-frame 8. Quick assembly of the curved pipe 2a relative to the node 3 is thereby ensured, also by means of the maintenance opening 15a, which thus allows for the passage of a commonly available hex head screw driver and safe turning of the screw 12 at a minimal screw-in angle.

FIG. 5 shows a schematic side view of a node 3 with three pipes 2, 2a, wherein a curved pipe 2a is not disposed at a right angle relative to the two straight pipes 2 and provided with a guide stump 20, and possibly a positioning pin 21, and that includes a screw 12, and the curved pipe 2a is mounted to guide stump 20 by means of the joint 1a. This connection technique includes three types of connection possibilities, namely, one in which the guide stump 20 is attached to the node 3, be it screwed by the screw 12 and correctly positioned by means of the positioning pin 21, followed by the curved pipe 2a being positioned on the guide stump 20 by way of the joint 1a, meaning it is, advantageously glued or shrunk. Shrinking is a method in which the, for example, curved pipe 2a is heated, the guide stump 20, on the other hand, is cooled, and the parts can be joined by means of material expansion and/or material shrinkage.

Instead of screws, it is also possible to use a modern rivet method; whereby the rivets quickly and safely connect the parts using a placement machine, such that the guide stump 20 is connected by rivets to the node 3, and then the curved pipe 2a is shrunk onto the guide stump 20, or the curved pipe 2a and the guide stump 20 are first shrunk by means of a template, and the screw 12 is connected to the node 3 by means of a maintenance opening 15a, which is presently not shown. An optimal joint 1a is provides for the node 3, the guide stump 20 and the pipe 2, 2a to be connected in a single work step; and wherein, moreover, the connection is achieved without screw 12, and instead of a threaded hole 5 there is only a corresponding positioning hole. This connection technique is also expedient for connecting a straight pipe 2 with a node 3.

FIG. 6 shows a schematic side view of a curved clamping device 10 that, lying straight, also serves as a clamping device 10, and shows a straight pipe 2 with a screw 12 inserted therein, which is screwed in at a node 3 and has located there-between separated expanding elements 22 with tapered intermediate elements 23, as well as a non-screwed protection cover on the threaded holes 5.

Shown is a pipe 2, wherein this construction is ideally suited for a curved pipe 2a in that positive or frictional expanding elements 22 and intermediate elements 23 are provided as segment parts on a screw 12, whereby, by means of over-dimensional holes 24, displacing the respective element in the curved pipe 2a is possible at any time. To simplify the assembly, it is possible for the segment parts, expanding elements 22 and intermediate elements 23 to be connected by means of a flexible material, for example, a rubber means, such that they can be pulled onto the screw 12, safe from being lost while, simultaneously, flexible enough to adjust to a curve of a curved pipe 2a.

By inserting the screw 12 in the threaded holes 5 of the node 3, the expanding elements 22 are pressed against the tapered intermediate elements 23 and, owning to a cut inside the respective expanding element 22, the same can be widened, meaning it slides up on the tapered intermediate element 23 and is ultimately pressed against the inside wall of the pipe 2 and/or curve pipe 2a, which is how a holding force is achieved. Such expanding elements 22 can be mounted on the screw 12 multiple times and can have diverse shapes such as, for example a circumferentially flat shape, such that an area that is as large as possible is pressed against the pipe 2, 2a creating a frictional closure shape or a pointed shape in order to press a recess into the pipe 2, 2a in order to thereby achieve a positive closure connection, or in that the pipe 2, 2a was pre-treated having a groove 25 or a thread in which a round wire presses to the outside as a snap ring, meaning as expanding elements 22, finding space inside the groove 25 and thereby also creating a positive connection.

It is not possible to assume with certainty that a modular furniture system is not to be expanded sometime in the future by the addition of further modules. To safely account for this possibility, the last side B should also be provided with threaded holes 5 such so as to ensure that the system can thereby still be quickly and easily expanded. In the meantime, the threaded holes 5 should be sealed off for reasons of a more pleasing optical appearance and reasons of hygiene, not, however, with machine-type screws 12 but instead with protective caps 26 that do not have slots conforming to any screw driver; instead, they are just pressed into the opening and the color thereof corresponds to that of the nodes 3, or they feature a logo as an optimal characteristic of recognition.

In principle, the above applies only for single-row furniture that are to be expanded by a second row. All multi-row pieces of furniture can be enlarged correspondingly by means of intermediate pipes and without any need for threaded holes 5 on the sides. A correspondingly shaped protective cap can also be offered for the maintenance opening 15,15.

Typically, pipes 2 and nodes 3 are commonly available and can be purchased made of chrome-plated steel or anodized-silver aluminum. For reasons of corrosion and wear and tear, the pipes 2, 2a are additionally hardened by black-chromium plating or, still better, DLC coating applied in a PE-PVD process, which increases the resistance against corrosion still further while applying another color, namely black, or/and while applying a further protective coating by means of a powder coating, whereby the color black is more than corrosion protection.

Furthermore, in moist geographical areas, particularly close to an ocean, it does not make much sense to produce clamping devices 11 of aluminum and pipes 2, 2a of steel, as this can result in excessive corrosion of the clamping device 11; which is why the clamping device 11 or the bend clamping device 10 should be produced as steel elements, or for even better corrosion protection and pricing from Nibral, meaning of nickel, aluminum, copper alloy.

It is understood that the invention is not limited to the shown and described embodiments.

### LIST OF REFERENCE SIGNS

1 Connecting means
1a Joint
2 Straight pipe
2a Curved pipe
3 Node
4 Cube
5 Threaded hole
6 Frame
7 Half-frame
8 Curved half-frame
9 Curved frame
10 Bend-clamping device
11 Clamping device
12 Screw
13 Maintenance hole
14 Bend-expanding means
14a Expanding body
15,15a Maintenance opening
16 Thread
17 Slot
18 Setscrew
19 Internal wall
20 Guide stump
21 Positioning pin
22 Expansion element
23 Intermediate element
24 Hole
25 Groove
26 Protective cover

1. A cube (4),
characterized
in that the cube (4) includes straight pipes (2) or/and curved pipes (2) that are mounted on nodes (3) with the minimum possible number of visible threaded holes (5), and constituting by way of connecting means (1) or/and joint (1a) an area-shaped or cuboid-shaped or round-shaped piece of furniture, and in that the connecting means (1) can be a bend-clamping device (10) or a clamping device (11) or a bend-expanding device (14),

2. The cube (4) according to claim 1,
characterized
in that the node (3) has a threaded hole (5) that is drilled at an angle relative to the right-angle threaded hole (5) that extends relative to the center (Z) and includes a single or a plurality of maintenance holes (13), or in that node (3) with a threaded hole (5) that is externally centered.

3. The cube (4) according to claim 1,
characterized
in that the node (3) is connected to a bend-clamping device (10) made of an expansion body (14a) having a slot (17) with an abeam-running thread (16) that guides a setscrew (18), and a pipe (2, 2a) is guided via the bend-clamping device (10) and clamped by a positive or frictional closure.

4. The cube (4) according to claim 1,
characterized
in that the node (3) includes a connecting means (1) or a guide stump (20) and is held by means of a screw (12) or rivet or joint (1a).

5. The cube (4) according to claim 1,
characterized
in that the pipe (2, 2a) includes a connecting means (1) or a guide stump (20) and is held by means of a screw (12) or setscrew (18) or joint (1a) and fastened to the node (3).

6. The cube (4) according to claim 1,
characterized
in that the node (3) and the guide stump (20) and the pipe (2, 2a) are connected in one work step by means of a joint (1).

7. The cube (4) according to claim 1,
characterized
in that the guide stump (20) serves as a joint (1a) for the pipe (2, 2a) and can also be attached to the node (3) asymmetrically.

8. The cube (4) according to claim 1,
characterized
in that a positioning pin (21) is mounted between node (3) and guide stump (20) for assembling a curved pipe (2a), or in that a template is used for the assembly.

9. The cube (4) according to claim 1,
characterized
in that the bend-clamping device (10) includes a screw (12) with a single or a plurality of expanding elements (22) attached thereto as well as tapered intermediate elements (23), and in that the expanding element (22) and the tapered intermediate element (23) include a bore hole (24) allowing to follow the radian measure of the curved pipe (2a) and fitting on straight pipes (2).

10. The cube (4) according to claim 1,
characterized
in that the expanding (22) has a flat or a pointed or a rounded external surface, or/and in that the pipe (2, 2a) has a groove (25).

11. The cube (4) according to claim 1,
characterized
in that the connecting means (1) or the bend-expanding device (14) and the interior of the pipe (2, 2a) have a granularity constituting a positive connection of a micro-level.

12. The cube (4) according to claim 1,
characterized
in that the pipe (2) is straight or the pipe (2a) is curved and can be, using the nodes (3), closed or open and rectangular or curved, and in that a cube (4) is formed using vertical pipes (2).

13. The cube (4) according to claim 1,
characterized
in that the position of the nodes (3) and the connection type of a piece of furniture determines the number of the threaded holes (5) per node (3), or/and in that unused threaded holes (5) or maintenance openings (15,15a) can be closed by means of a protective cover (26), and in that the joint (1a) renders the threaded hole (5) obsolete.

14. The cube (4) according to claim 1,
characterized
in that a software calculates the optimum number of threaded holes (5) per node (3) and the optimal connection type, as well as the assembly steps for the pieces of furniture.

15. The cube (4) according to claim 1,
characterized
in that the node (3) or/and pipes (2, 2a) are, to improve corrosion-fastness, black chrome plated or DLC- or powder coated or provided with another finish.
